(19) United States
(12) Patent Application Publication
(10) Pub. No.: US 2001/0030089 A1
(43) Pub. Date: Oct. 18, 2001

(54) Dragless brake caliper

(75) Inventor: David B. Drennen, Bellbrook, OH (US)

Correspondence Address: DELPHI TECHNOLOGIES, INC., Legal Staff, Mail Code: 482-204-450, P.O. Box 5052, 1450 W. Long Lake, Troy, MI, 48098, US

(73) Assignee: DELPHI TECHNOLOGIES INC.

(21) Appl. No.: 09/784,594

(22) Filed: Feb. 15, 2001

Related U.S. Application Data
(63) Continuation-in-part of application No. 09/634,900, filed on Aug. 9, 2000.
(60) Provisional application No. 60/167,345, filed on Nov. 24, 1999.

(51) Int. Cl. F16D 55/08

(52) U.S. Cl. 188/72.1; 188/71.1

(57) ABSTRACT

The dragless brake assembly which can be either hydraulic or electrical incorporates a ballscrew engaged to the inner brake assembly, and an outer brake assembly engaged to a sliding caliper housing, the ballscrew and caliper housing being mechanically engaged to move in directions opposite each other simultaneously between predefined limits for application or release of braking.

### CROSS REFERENCE TO RELATED APPLICATION

This application is a continuation in part of U.S. application Ser. No. 09/634,900 filed Aug. 9, 2000 and entitled Electric Brake Caliper, which application claims priority from U.S. Provisional application Ser. No. 60/167,345, filed Nov. 24, 1999.

### TECHNICAL FIELD

The present invention relates to dragless automotive braking systems of both the hydraulic and electric type incorporating a sliding brake caliper assembly. More particularly, the dragless brake caliper assembly of the present invention substantially reduces, if not altogether eliminates, brake drag, by incorporating an antirotation ballscrew therein, in place of the typical piston assembly presently used in calipers of the electric and hydraulic type.

### BACKGROUND OF THE INVENTION

Heretofore, automotive brake assemblies, both of the hydraulic and electric caliper type, have inherently incorporated drag during braking which decreases fuel economy, shortens the useful life of brake linings, and complicates required brake suspension design to accommodate for the drag created by the assembly.

Accordingly, there is a need in the industry for a dragless brake caliper assembly, which will overcome shortfalls inherent in the prior art.

An exemplary brake caliper of the electric type to which the improvement of the subject application applies is disclosed in U.S. application Ser. No. 09/634,900 filed on Aug. 9, 2000 and entitled Electric Brake Caliper, the teachings of which are incorporated herein by reference.

### SUMMARY OF THE INVENTION

According to the invention there is provided a brake caliper assembly comprising at least an inner brake assembly mounted to a reciprocable actuating mechanism and an outer brake assembly mounted to a sliding caliper housing, the actuating mechanism and the sliding caliper housing being mechanically engaged in a manner to move opposite each other about a wheel rotor positioned between the brake assemblies, the actuating mechanism comprising a driven ballscrew reciprocating between a predefined home position retracting both brake assemblies and a predefined braking position engaging the assemblies against the rotor.

### BRIEF DESCRIPTION OF THE DRAWINGS

FIG. 1 is a perspective view of the brake caliper assembly of the present invention as viewed toward an inner caliper of the assembly;

FIG. 2 is a perspective view of the brake caliper assembly of the present invention as viewed toward an outer caliper of the assembly;

FIG. 3 is a perspective view of the brake caliper assembly of the present invention as viewed toward a housing of the caliper assembly; and

FIG. 4 is a perspective view of the brake caliper assembly of the present invention as viewed toward a mounting bracket thereof.

### DESCRIPTION OF THE PREFERRED EMBODIMENT

The structure proposed herein, which is equally applicable to both electric and hydraulic brake calipers, incorporates an antirotation ballscrew for activation of the caliper within defined limits, which has been found through empirical testing to significantly reduce, if not altogether eliminate brake drag.

To provide a simple overview of the functionality of a caliper assembly, the following synopsis is provided.

Various types of brake systems are known for use in automotive vehicles. Such brake systems include, for example, hydraulic brakes, anti-lock brakes and electric brakes. Electric brake systems (also referred to as “brake by wire” systems) utilize caliper mechanisms that incorporate an electric motor for driving a gear assembly positioned within the caliper housing, which, in turn, drives an inner brake pad against a brake rotor disc of a vehicle. A second, outer brake pad mounted to the caliper housing is positioned on an opposite side of the rotor disc. During braking, the inner brake pad is forced against the rotor disc and a resulting reactionary force pulls the outer break pad into engagement with the opposite side of the disc. Engagement of the inner and outer brake pads will slow or stop rotation of the rotor disc, and, in turn, slow the vehicle or hold the vehicle in a fixed position.

A load sensor is typically positioned to detect the amount of force applied by the inner break pad to the rotor disc. This load sensor is operatively coupled to a mechanism for controlling the position of the caliper housing, and in turn, the force applied by the outer break pad to equalize (or “center”) the force applied by the two brake pads on the rotor disc.

Such caliper assembly includes at least a brake caliper that comprises a caliper housing having a rotor channel adapted to receive a rotor (such as a rotor disc) therein, where the rotor channel has a first axial surface adapted to seat an outer brake pad thereon. The brake caliper also includes a piston assembly mounted to the housing on an axial side of the rotor channel opposite that of the outer brake pad. The piston assembly includes a piston nut, reciprocatable towards and away from the rotor channel, where the piston nut is adapted to seat an inner brake pad thereon, a driven screw threaded into the piston nut, which axially drives the piston nut towards or away from the rotor disc in the rotor channel.

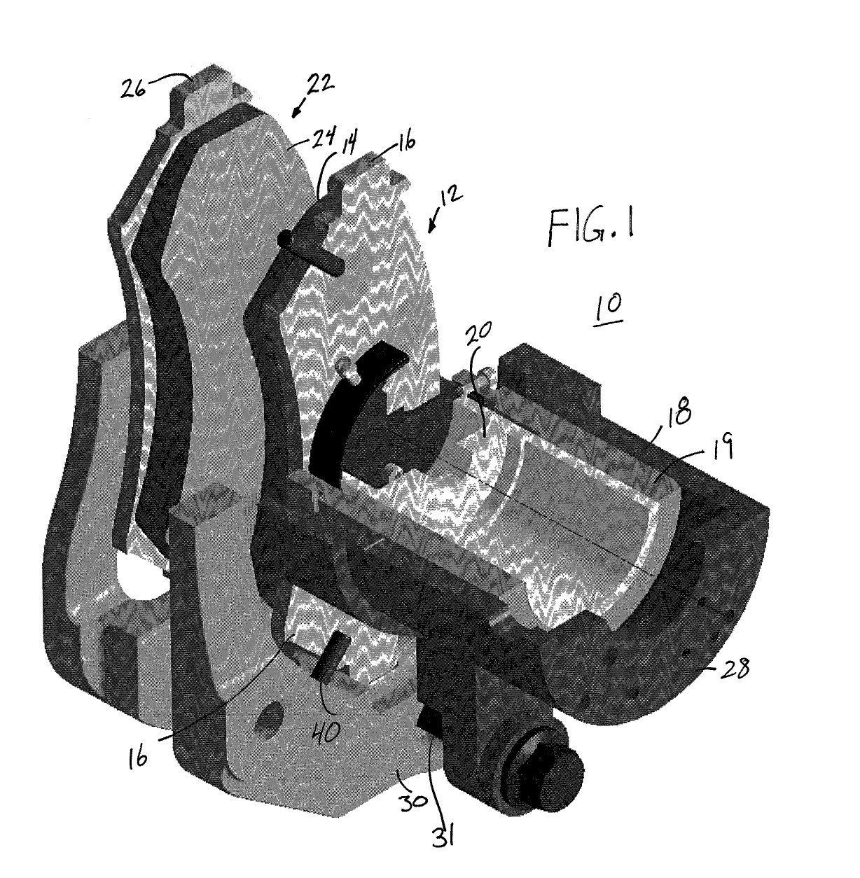

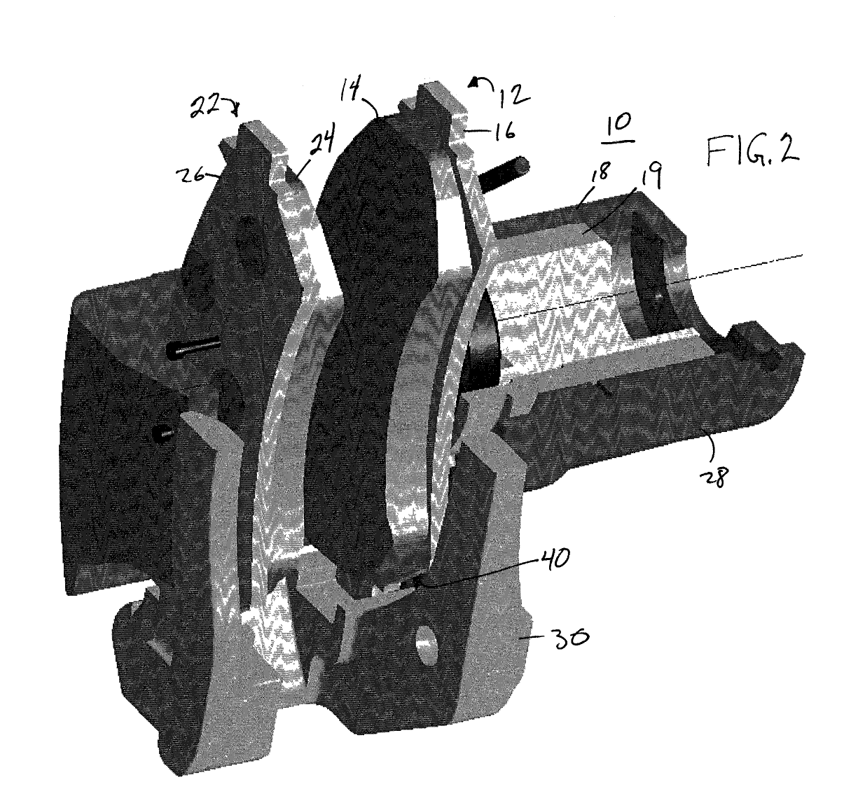

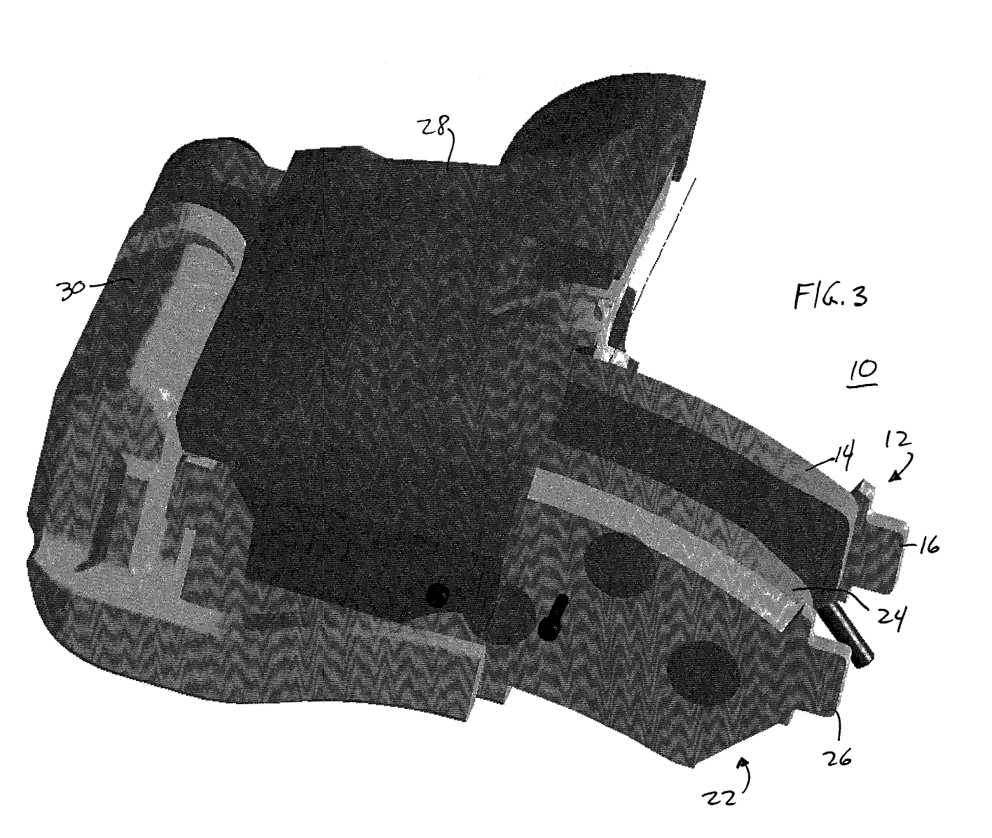

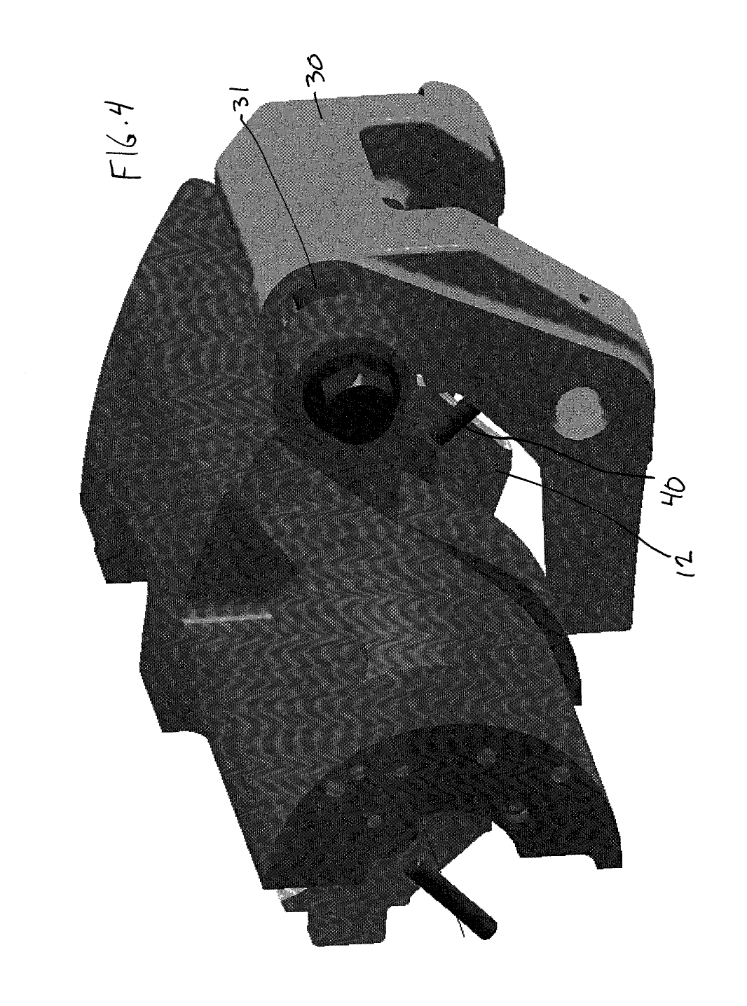

As illustrated in FIGS. 1-4, the brake caliper assembly 10 of the present invention which is applicable for use in either an electric or hydraulic braking system includes an inner brake assembly 12 comprising an inner brake pad 14 suitably mounted to an inner brake shoe 16. The inner brake shoe 16 is suitably fixed to a drive mechanism 18 therefore, which in the preferred embodiment disclosed herein comprises a ball nut 19 of a ball screw 20. An outer brake assembly 22 comprising a brake pad 24 suitably mounted to an outer brake shoe 26 is suitably attached on the other hand, to a caliper housing 28 via the brake shoe 26. A caliper bracket 30 is also incorporated into the assembly 10, the bracket 30 serving as a brake pad guide, and a load transfer mechanism, with the caliper housing 28 being mounted on and reciprocably slidable along a mounting rod 31 of the bracket 30 within predefined limits.

In operation, during application of the brakes by a driver through brake pedal (not shown) actuation, the inner brake assembly 12 is moved toward outer brake assembly 22 driving brake pad 14 mounted to brake shoe 16 of the assembly 12 against and into an inner rotor face (not shown). Reactionary force, due to mechanical engagement between the ballscrew 20 and the caliper housing 28, causes the caliper housing 28 to move in a direction opposite that of the ball nut 18, pulling outer brake assembly 22 attached thereto into an outer rotor face (not shown), with the assemblies 12 and 22 clamping the rotor therebetween and creating desired braking. This scenario, as stated above, is applicable to either hydraulic or electric braking systems.

Conversely, upon release of the brake pedal by the driver, the brake assemblies 12 and 22 are pulled away from the rotor by opposite action of the drive mechanism 18 and reaction of the caliper housing 28, creating a clearance between the assemblies 12 and 22 and the rotor sandwiched therebetween.

In conventional hydraulic brake assemblies, a hydraulic seal around an actuating piston (not shown) thereof is designed to retract the piston from the rotor somewhat, with retraction being dependent on a sliding bracket suspension, the applied force, and the time duration for rubber to contract, as is known.

In the assembly 10 of the present invention, however, when the ballscrew 20 is incorporated into the assembly 10 in place of the conventional piston assembly, when the inner brake assembly 12 is retracted and reaches a home position against stop 40 on bracket 30, an axial load is transferred to the caliper housing 28 slidably mounted to the rod 31 of bracket 30, moving the housing 28 in a direction opposite that of inner brake assembly 12 retraction and thus simultaneously moving the outer brake assembly 22 away from the rotor, in an action opposite that incurred during brake application, creating a clearance between the brake assemblies 12 and 22 and the rotor therebetween, thereby significantly reducing, if not altogether eliminating brake drag.

Provision of such a clearance between the brake assemblies 12 and 22 and the rotor, as well the degree of clearance created, is understood to be dependent on rotor run out and acceptable predetermined parameters of rotor to pad clearance. The position of the pads 14 and 24 of the assemblies 12 and 22, respectively, as they relate to position of the rotor therebetween, may be monitored by a motor position encoder (not shown) or alternatively by a position sensor (not shown) which may be located on the ballscrew 20 itself, if required.

In the assembly 10, it is understood that predetermined parameters of rotor to pad clearance also take into account wheel speed, with low speeds requiring a greater degree of clearance and high speeds requiring a lesser degree of clearance.

As described above, the assembly 10 provides a number of advantages, some of which have been described above and others of which are inherent in the invention. Also modifications may be proposed without departing from the teachings herein. Accordingly the scope of the invention is only to be limited as necessitated by the accompanying claims.

1. A brake caliper assembly comprising at least an inner brake assembly, mounted to a reciprocable actuating mechanism and an outer brake assembly mounted to a sliding caliper housing the actuating mechanism and the sliding caliper housing being mechanically engaged in a manner to move opposite each other for causing engagement of the inner and outer brake assemblies against a wheel rotor positioned therebetween in a predefined braking position, the actuating mechanism comprising a driven ballscrew reciprocating a predefined home position retracting both brake assemblies and the predefined braking position.

2. In a brake by wire braking system including a brake caliper assembly comprising at least an inner brake assembly, mounted to a reciprocable actuating mechanism and an outer brake assembly mounted to a sliding caliper housing the actuating mechanism and the sliding caliper housing being mechanically engaged in a manner to move opposite each other for causing engagement of the inner and outer brake assemblies against a wheel rotor positioned therebetween in a predefined braking position, the actuating mechanism comprising a driven ballscrew reciprocating a predefined home position retracting both brake assemblies and the predefined braking position.

3. In a braking system of the hydraulic type including a brake caliper assembly comprising at least an inner brake assembly, mounted to a reciprocable actuating mechanism and an outer brake assembly mounted to a sliding caliper housing the actuating mechanism and the sliding caliper housing being mechanically engaged in a manner to move opposite each other for causing engagement of the inner and outer brake assemblies against a wheel rotor positioned therebetween in a predefined braking position, the actuating mechanism comprising a driven ballscrew reciprocating a predefined home position retracting both brake assemblies and the predefined braking position.

4. In a vehicular braking system including a brake caliper assembly comprising at least an inner brake assembly, mounted to a reciprocable actuating mechanism and an outer brake assembly mounted to a sliding caliper housing the actuating mechanism and the sliding caliper housing being mechanically engaged in a manner to move opposite each other for causing engagement of the inner and outer brake assemblies against a wheel rotor positioned therebetween in a predefined braking position, the actuating mechanism comprising a driven ballscrew reciprocating a predefined home position retracting both brake assemblies and the predefined braking position.

5. A brake caliper assembly comprising:
a sliding caliper housing having an outer brake assembly mounted thereto, and being slidingly engaged to a bracket of the assembly;
a reciprocable inner brake assembly mounted to an actuating mechanism mechanically engaged to the sliding caliper housing in a manner to cause the inner brake assembly and the sliding caliper housing to each move toward and away from one another to simultaneously apply and release braking pressure, respectively, against a rotor positioned therebetween.

6. The brake caliper assembly of claim 5 wherein the actuating mechanism comprises a ballscrew.

7. The brake caliper assembly of claim 5 wherein the inner brake assembly is mounted to a ball nut of the ballscrew.

8. The brake caliper assembly of claim 5 wherein the bracket includes a stop member thereon against which the inner brake assembly abuts to limit retraction thereof, the stop member defining a home position for the inner brake assembly.

9. The brake caliper assembly of claim 8 wherein the sliding caliper housing is moved in a direction opposite that of the inner brake assembly upon abutment of the inner brake assembly against the stop member.

10. The brake caliper assembly of claim 9 wherein the sliding caliper housing is moved in a direction opposite that of the inner brake assembly when the inner brake assembly reaches a predefined limit of extension.
